(19) United States
(12) Patent Application Publication
(10) Pub. No.: US 2011/0149032 A1
(43) Pub. Date: Jun. 23, 2011

(54) TRANSMISSION AND HANDLING OF THREE-DIMENSIONAL VIDEO CONTENT

(75) Inventors: Hoon Choi, Mountain View, CA (US); Daekyeung Kim, Palo Alto, CA (US); Wooseung Yang, Santa Clara, CA (US); Young Il Kim, Sunnyvale, CA (US); Jeoong Sung Park, Sunnyvale, CA (US)

(73) Assignee: SILICON IMAGE, INC., Sunnyvale, CA (US)

(21) Appl. No.: 12/966,194

(22) Filed: Dec. 13, 2010

Related U.S. Application Data
(60) Provisional application No. 61/287,684, filed on Dec. 17, 2009.

(51) Int. Cl. H04N 13/00

(52) U.S. Cl. 348/43; 348/E13.001

(57) ABSTRACT

Embodiments of the invention are generally directed to transmission and handling of three-dimensional video content. An embodiment of a method includes receiving a multimedia data stream including video data utilizing an interface protocol and determining that the received video data includes three-dimensional (3D) video data, where each frame of the video data includes a first vertical synchronization (Vsync) signal prior to an active data region, the active data region including a first data region and a second data region. The method further includes converting the 3D video data from a 3D data format to a two-dimensional (2D) video format, where converting the 3D video data includes identifying a region between the first data region and the second data region, inserting a second Vsync signal between the first data region and the second data region, and providing an identifier to distinguish between the first data region and the second data region.

### RELATED APPLICATIONS

This application is related to and claims priority to U.S. Provisional Patent Application No. 61/287,684, filed Dec. 17, 2009, the entire contents of which are hereby incorporated by reference.

### TECHNICAL FIELD

Embodiments of the invention generally relate to the field of data communications and, more particularly, transmission and handling of three-dimensional video content.

### BACKGROUND

In certain networks, content data may be transmitted over a data link between a first device and a second device in various transmission formats. For example, the content may represent video and audio data, and thus may include video content data that is transmitted in a certain format.

In certain operations, a data stream may be in the form of multiple channels. For example, data may include a data stream of video and audio data or other content data sent from a first device to second device, where the content data includes multiple data channels encapsulated in a three-dimensional (3D) format that includes, for example, a left channel and a right channel. For example, the data may be in the form of HDMI™ 1.4 (High Definition Multimedia Interface 1.4 Specification, issued May 28, 2009) 3D video data.

In contrast to two-dimensional (2D) video format that generally provides a single image to both eyes of a viewer, 3D video formats allow the viewer to see slightly different images in each eye to create the illusion of depth in an image. In certain implementations, the transmission of 3D video data requires delivery of two active video regions: a left region and a right region.

However, the reception of 3D video format data generally requires that a receiving device be operable to handle such data. A receiving device that is designed for handling 2D data will not be capable of handling the 3D video format data.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates an embodiment of a system configuration for converting 3D video into 2D video format;

FIG. 2 illustrates an embodiment of a conversion of 3D video format video data;

FIG. 3 illustrates an embodiment of a system configuration with a dedicated signal indicating a data region type;

FIG. 4 illustrates an embodiment of a system configuration including a modified protocol to indicate region type;

FIG. 5 illustrates an embodiment of conversion of 3D data for transmission to a receiver without 3D decoding capability;

FIG. 6 illustrates an embodiment of conversion of 3D video data into 2D video format;

FIG. 7 illustrates an embodiment of an HDMI 3D-to-2D format converter;

FIG. 8 is a flowchart to illustrate an embodiment of a process for conversion and utilization of 3D video data;

FIG. 9 is a flowchart to illustrate an embodiment of a process for handling 3D video data in 2D video data format; and

FIG. 10 illustrates an embodiment of an electronic device.

### SUMMARY

Embodiments of the invention are generally directed to transmission and handling of three-dimensional video content.

In a first aspect of the invention, an embodiment of a method includes receiving a multimedia data stream including video data utilizing an interface protocol and determining that the received video data includes three-dimensional (3D) video data, where each frame of the video data includes a first vertical synchronization (Vsync) signal prior to an active data region, the active data region including a first data region and a second data region. The method further includes converting the 3D video data from a 3D data format to a two-dimensional (2D) video format, where converting the 3D video data includes identifying a region between the first data region and the second data region, inserting a second Vsync signal between the first data region and the second data region, and providing an identifier to distinguish between the first data region and the second data region.

In a second aspect of the invention, an embodiment of an apparatus to convert three-dimensional (3D) video data to a two-dimensional (2D) data format includes a port to receive video data via an interface protocol and a decoder to decode the received video data. The apparatus further includes a detector to detect received 3D video data, the received 3D video data including a first vertical synchronization (Vsync) signal prior to an active data region, the active data region including a first data region and a second data region; a line counter to identify a region between the first data region and the second data region; a signal inserter to insert a second Vsync signal between the first data region and the second data region; and an encoder to encode the converted video data. The apparatus is to provide an identifier to distinguish between the first data region and the second data region.

### DETAILED DESCRIPTION

In some embodiments, a method and apparatus provide for transmission and handling of three-dimensional video content.

In some embodiments, a method and apparatus provide for transmission of a multimedia data stream including three-dimensional (3D) video content data, such as over an HDMI interface, including conversion of the data into a two-dimensional (2D) data format. In some embodiments, a method and apparatus utilize an identifier to distinguish between data regions in the converted data. In some embodiments, the identifier includes a phase-shifted synchronization signal. In some embodiments, a receiving device utilizes the phase-shifted synchronization signal to detect 3D video content data and to identify regions within the 3D data. In some embodiments, other identifiers are used to detect 3D data and to distinguish between data regions.

3D video formats allow a viewer to see slightly different images in each eye to create an illusion of depth in an image. In order to provide such images, transmission of 3D video data over HDMI or other protocols may utilize two active video regions, where such video regions may be referred to as a left region (for video images to be displayed to the left eye of a viewer) and a right region (for video images to be displayed to the right eye of a viewer). However, 3D may utilize different types of data regions, and embodiments are not limited to video data containing a left region and a right region. Embodiments are not limited to any particular interface protocol for the transfer of such data. In addition to HDMI, embodiments may include DVI™ (Digital Video Interface) (including Digital Display Interface Revision 1.0, Digital Display Working Group, Apr. 2, 1999), DisplayPort™ (including DisplayPort Version 1.2, Video Electronics Standards Association, Dec. 22, 2009 and earlier versions), and other protocols.

In some embodiments, in order to maintain compatibility with existing devices, such as existing HDMI devices that support only 2D video format, conversion of 3D video format to 2D video format is provided. However, 2D video format conventionally does not contain information to indicate which region of 3D video data is being transmitted. In some embodiments, 3D video data is transmitted in a 2D format that provides for identification of which region of the 3D video data is being transmitted. In some embodiments, a method or apparatus is provided to transmit 3D video data in 2D video format over HDMI without modifying hardware of existing HDMI receivers or violating the protocol of the HDMI specification. In some embodiments, a receiving device is a device that is not capable of decoding 3D video format. In some embodiments, a method or apparatus provides an identifier to distinguish between data regions in the converted video data.

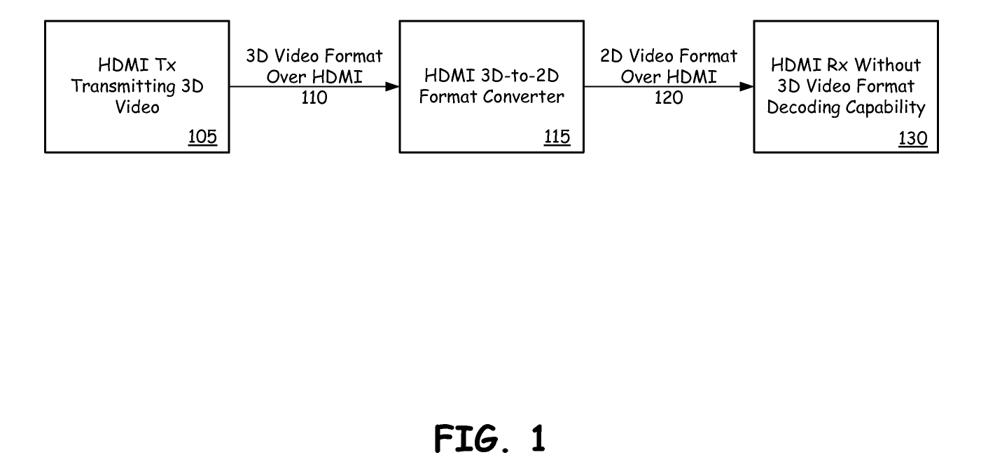

FIG. 1 illustrates an embodiment of a system configuration for converting 3D video into 2D video format. In some embodiments, a method and apparatus provides for converting 3D video data into 2D video format and transmitting such data for processing without modifying the existing HDMI receiver hardware or violating an interface protocol, such as HDMI. In this illustration, an HDMI transmitter operates to transmit a multimedia data stream including 3D video 105. Data in 3D video format is transferred via an HDMI connection 110 and is received by an HDMI 3D-to-2D converter 115, which converts the received 3D format data into 2D format and transmits converted multimedia data. In this illustration, data in 2D video format is transferred via an HDMI connection 120 to an HDMI receiver that is without 3D video format decoding capability 130. While FIG. 1 and the following described drawings may include HDMI as an example, embodiments are not limited to HDMI protocol for the transfer of data. Embodiments may also include DVI, DisplayPort, and other protocols in the transfer of data.

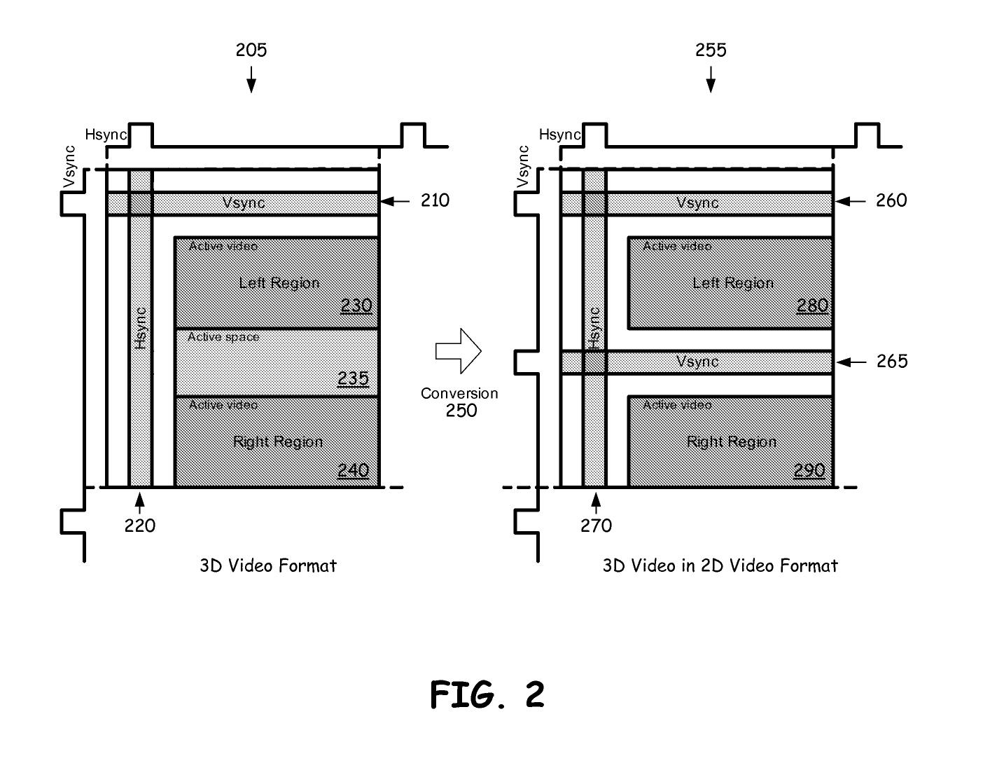

FIG. 2 illustrates an embodiment of a conversion of 3D video format video data. In this illustration, a timing diagram for 3D video format 205 is provided, where the video data is subject to conversion 250 to provide 3D video in a 2D video format 255. As illustrated in FIG. 2, in the 3D video format 205 there may be two “active video” regions, i.e., a left region 230 and a right region 240, and an “active space” 235 that together compose a 3D active video. Also illustrated is a vertical synchronization signal (Vsync) 210 and horizontal synchronization signals (Hsync) 220.

In some embodiments, in order to allow existing receivers without 3D decoding capability to decode the 3D video format, the 3D active video format 205 is split into two 2D active video segments, a left region 280 and a right region 290, as shown in the 2D video format 255. The format again includes the Vsync signal 260 and the Hsync signals 270. In some embodiments, a new Vsync signal 265 is inserted between the left region 280 and the right region 290 in place of the active space 235 in the 3D video format 205 to maintain compatibility with a 2D video format. In some embodiments, the resulting format is 3D video data that is contained in a 2D video format.

A potential issue in data processing is that the conversion process for 3D video data as illustrated in FIG. 2 may retain the information concerning which data region is being transmitted at a particular point in time. Thus, when the HDMI receiver 130 illustrated in FIG. 1 decodes the 2D video format 255 as illustrated in FIG. 2, the receiver 130 may not be capable of determining whether a current active video is a left region 280 or a right region 290. In some embodiments, an identifier is provided to distinguish between the left region 280 and the right region 290.

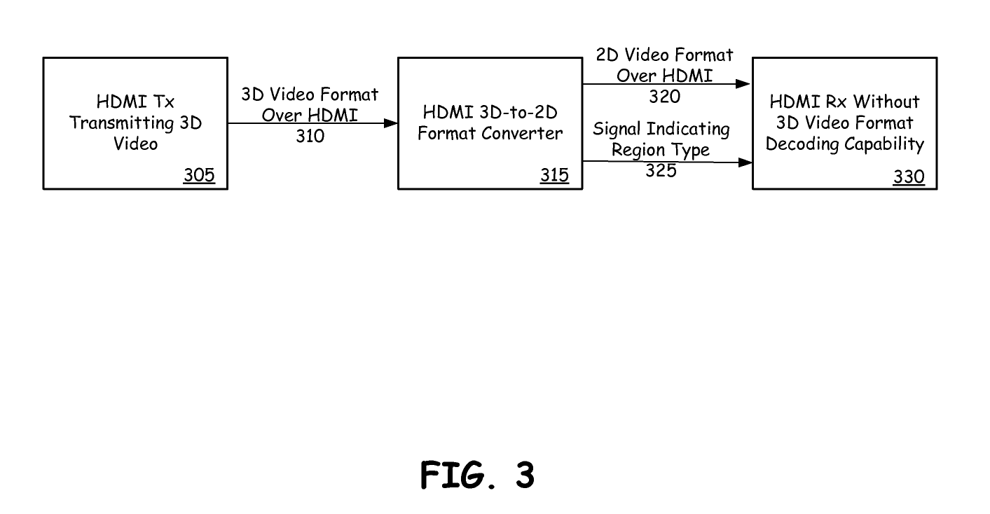

FIG. 3 illustrates an embodiment of a system configuration with a dedicated signal indicating a data region type. In FIG. 3, an HDMI transmitter operates to transmit a multimedia data stream including 3D video data 305. Data in 3D video format is transferred via an HDMI connection 310 and is received by an HDMI 3D-to-2D converter 315, which converts the received 3D format data into a 2D data format and transmits the converted multimedia data. In this illustration, 3D data in 2D video format is transferred via an HDMI connection 320 to an HDMI receiver that does not include 3D video format decoding capability 330. In some embodiments, a signal wire is provided to carry an identification signal to notify a receiver regarding the region type of video data. In this illustration, a signal indicating the region type transferred via the signal wire 325 is transferred to the receiver 330. In some embodiments, for each active video region, the HDMI 3D-to-2D format converter 315 toggles this signal 325 to notify the HDMI receiver 330 regarding the current region type of the video data. The implementation illustrated in FIG. 3 may be utilized to provide a simple mechanism to identify the appropriate region type of received video data. However, the mechanism may require certain additional hardware cost for a dedicated wire to carry the signal 325. In addition, existing HDMI receiver hardware may require certain modification to receive and decode the new signal 325.

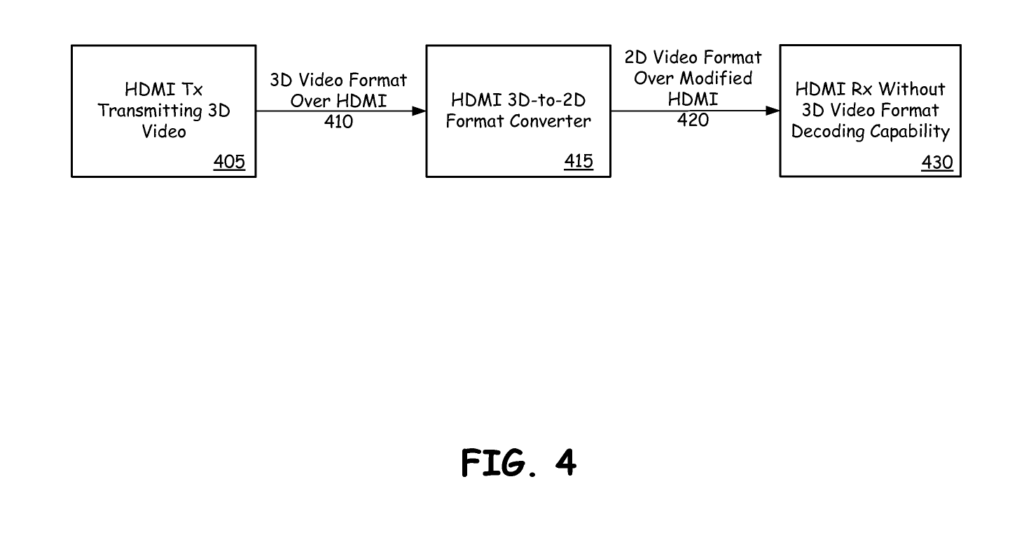

FIG. 4 illustrates an embodiment of a system configuration including a modified protocol to indicate region type. In this illustration, HDMI protocol is modified to deliver information on the region type for decoding by a receiving unit. As provided in FIG. 4, an HDMI transmitter operates to transmit a multimedia data stream including 3D video data 405. Data in 3D video format is transferred via an HDMI connection 410 and is received by an HDMI 3D-to-2D converter 415, which converts the received 3D format data into 2D format and transmits converted multimedia data. However, data in 2D video format is transferred utilizing a modified HDMI format connection 420 to HDMI receiver 430, where the modified HDMI format allows for identification of the current region for decoding by the receiver 430.

A protocol may include unused control codes that may be used for identification of data regions in the transmission of video data. For example, there are several unused control codes that currently exist in the HDMI protocol. In one example, CTL0 is always logically high in the current HDMI 1.4 protocol. In some embodiments, this unused code or another unused code may be utilized to deliver an identifier of the region type for data regions to an HDMI receiver that is not enabled for 3D data decoding. However, the code use is inconsistent with the standard protocol of HDMI, and thus may cause communication error in certain HDMI receivers.

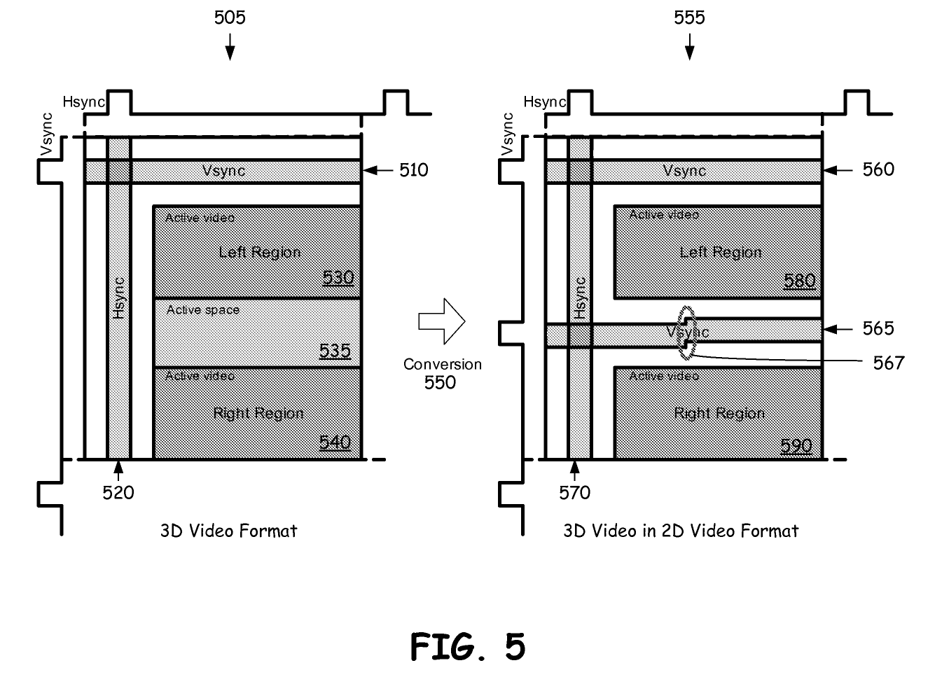

FIG. 5 illustrates an embodiment of conversion of 3D data for transmission to a receiver without 3D decoding capability. In this illustration, a timing diagram for 3D video format 505 is provided, including the two active video regions, the left region 530 and the right region 540, and the active space 535 that compose the 3D active video. Also illustrated are the Vsync signal 510 and the Hsync signals 520.

In some embodiments, the 3D active video format 505 is split into the two 2D active video segments, the left region 580 and the right region 590, as shown in the 2D video format 555. The format includes a first Vsync signal 560 and the Hsync signals 570. In some embodiments, a new second Vsync signal 565 is inserted between the left region 580 and the right region 590 in place of the active space 535 in the 3D video format 505 to maintain compatibility with a 2D video format. However, in some embodiments, the first Vsync 560 includes a different synchronization with regard to the Hsync signals 670 than does the second Vsync signal 565 to provide an identifier for data regions. In some embodiments, the phase of the first Vsync signal 560 is aligned with an Hsync signal, while the phase of the second Vsync signal 565 is not aligned with an Hsync signal, as illustrated by the unaligned point 567 shown in FIG. 5.

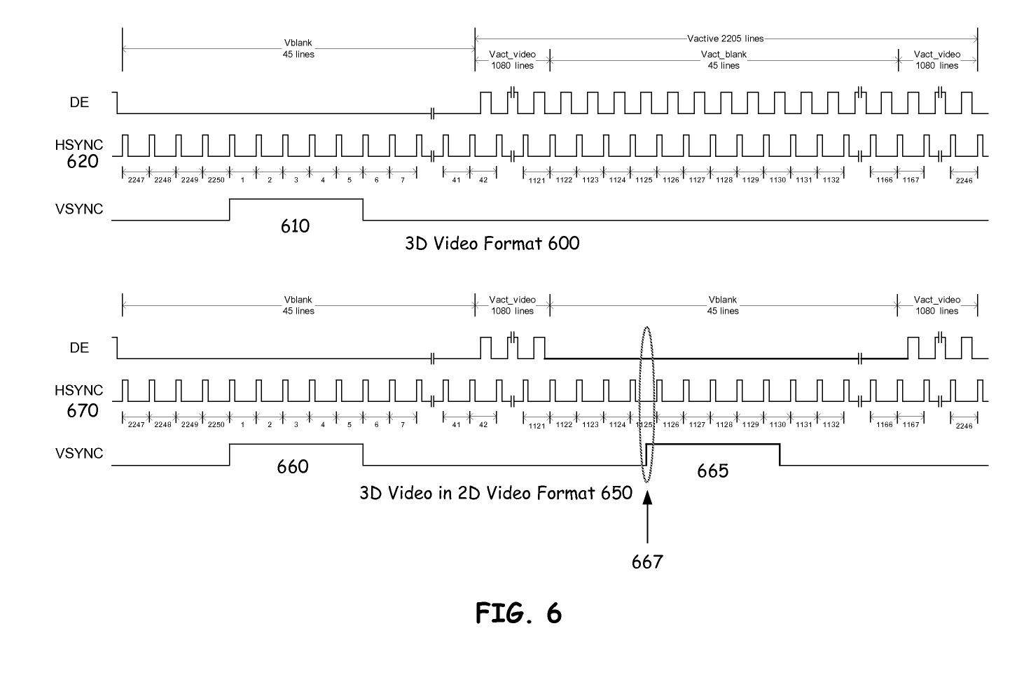

FIG. 6 illustrates an embodiment of conversion of 3D video data into 2D video format. In this illustration, a timing diagram for a 1080p (indicating 1080 scan lines of vertical resolution without interlacing of scan lines) 3D video format 600 is provided. As shown, a vertical blanking region (Vblank) of 45 lines is followed by an active period (Vactive) of 2205 lines, where the Vactive period includes a first active video region (Vact_video) of 1080 lines (which may represent the left region 530 of FIG. 5), an intervening blank region (Vact_blank) of 45 lines (which may represent the active space 535 of FIG. 5), and a second Vact_video region of 1080 lines (which may represent the right region 540 of FIG. 5). Also provided in the illustration are a data enable signal (DE) to indicate when valid pixels are present, the vertical synchronization signal (Vsync 610) to indicate the end of one frame and the beginning of the following frame (provided before the Vactive period) and the horizontal synchronization signal (Hsync 620) to indicate the end of each line and the beginning of the following line. As shown in FIG. 6, the phase of the Vsync signal 610 is aligned or synchronized with the Hsync signal 620.

In some embodiments, the 3D video format 600 is converted to 3D data in a 2D video format 650. In some embodiments, the 2D video format includes a different phase alignment or synchronization between Vsync and Hsync signals to identify different video regions. In this illustration, the timing of Vsync before the left region is different from that of the right region, where the region type of the following active video depends on whether or not Vsync is synchronized with Hsync. As illustrated, a Vblank region of 45 lines is again followed by a Vact_video region of 1080 lines, an intervening Vact_blank region of 45 lines, and a second Vact_video region of 1080 lines. Also provided in the illustrated embodiment are the DE signal, a first Vsync 660 to indicate the end of one frame and the beginning of the following frame (provided before the Vactive period), the Hsync 670 to indicate the end of each line and the beginning of the following line, and in addition a second Vsync signal 665 to indicate the end of the first active video region and the beginning of the second active video region. In some embodiments, the phase of the first Vsync signal 660 is aligned or synchronized with the Hsync signal 670 in the same manner as the 3D video format, but the phase of the second Vsync signal 665 is unaligned or unsynchronized 667 with the Hsync signal 670. In some embodiments, a receiving device may utilize the phase alignment of the Vsync and Hsync signals to identify 3D video data and to determine which video data region is being received. For example, a receiving device may determine that a left video data region is being received subsequent to a Vsync signal that is synchronized with an Hsync signal, while the receiving device may determine that a right video data region is being received subsequent to a Vsync signal that is not synchronized with an Hsync signal.

In some embodiments, the timing in the 2D video format 650 is the same as the timing of an interlaced mode video format of an existing HDMI signal, where even and odd fields are differentiated instead of left and right regions. In some embodiments, decoding hardware for interlaced mode video within an existing HDMI receiver may be utilized for decoding the 3D video date in 2D video format without additional hardware modification or with minimal hardware modification. In some embodiments, the lack of phase alignment between the second Vsync signal may be utilized to distinguish between interlaced video and 3D video data.

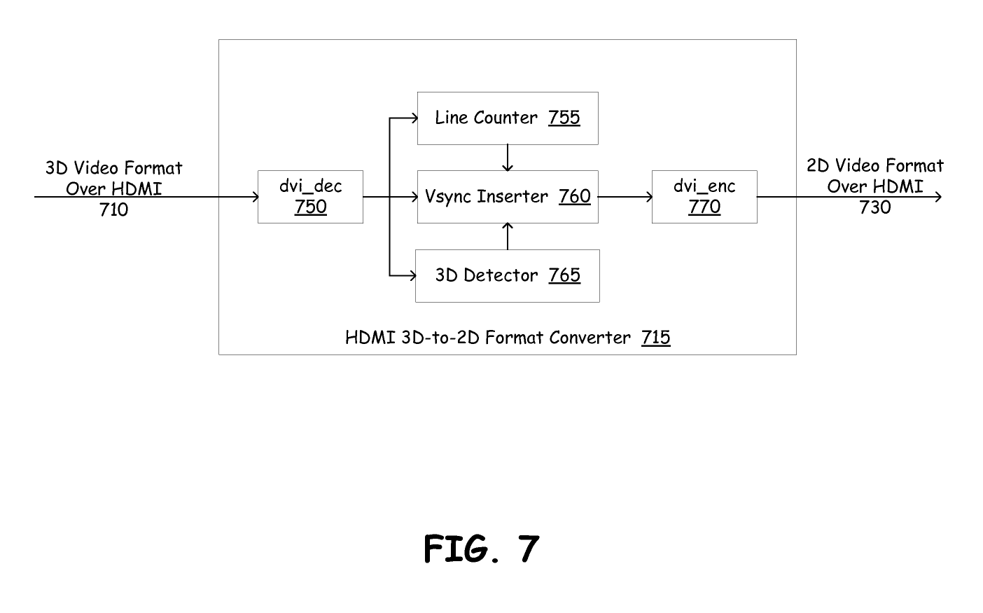

FIG. 7 illustrates an embodiment of an HDMI 3D-to-2D format converter. In some embodiments, transmitted multimedia data including video data is received by a 3D-to-2D converter device or mechanism. In some embodiments, an HDMI 3D-to-2D format converter 715 is operable to receive 3D video format data over an HDMI interface 710 and to transmit the data converted into 2D video format data for transfer over an HDMI interface 730. In some embodiments, the converter 715 includes modules or elements including a data decoder (dvi-dec, where DVI represents Digital Visual Interface standard) 750, where the decoded data is provided to modules or elements including a line counter 755, a Vsync inserter 760, and a 3D detector 765. In some embodiments, the 3D detector 765 analyzes a received data packet to determine whether the incoming HDMI stream is 2D video or 3D video. In some embodiments, if 3D video data is not detected, the data may be handled as normal 2D video data. In some embodiments, if 3D video format is detected, the line counter 755 then counts the lines to find the location of the active space (illustrated as active space 535 in FIG. 5) in the 3D video format. In some embodiments, the Vsync inserter 760 operates to insert a second Vsync signal in place of the active space. In some embodiments, the Vsync inserter 760 operates to shift the phase of the inserted Vsync signal in relation to Hsync signals according to the region type of the following active video so that an HDMI receiver may differentiate between left region data and right region data. In some embodiments, even though an HDMI receiver is not capable of decoding 3D video format, the receiver can reconstruct 3D video using the phase relationship between Vsync and Hsync signals without hardware modification. In some embodiments, the converted video data is provided to a video data encoder (dvi_enc) 770 and the resulting 2D video data is transmitted over an HDMI interface 730 to the data receiver, which the data receiving may include a data receiving device that is not 3D data decoding capable.

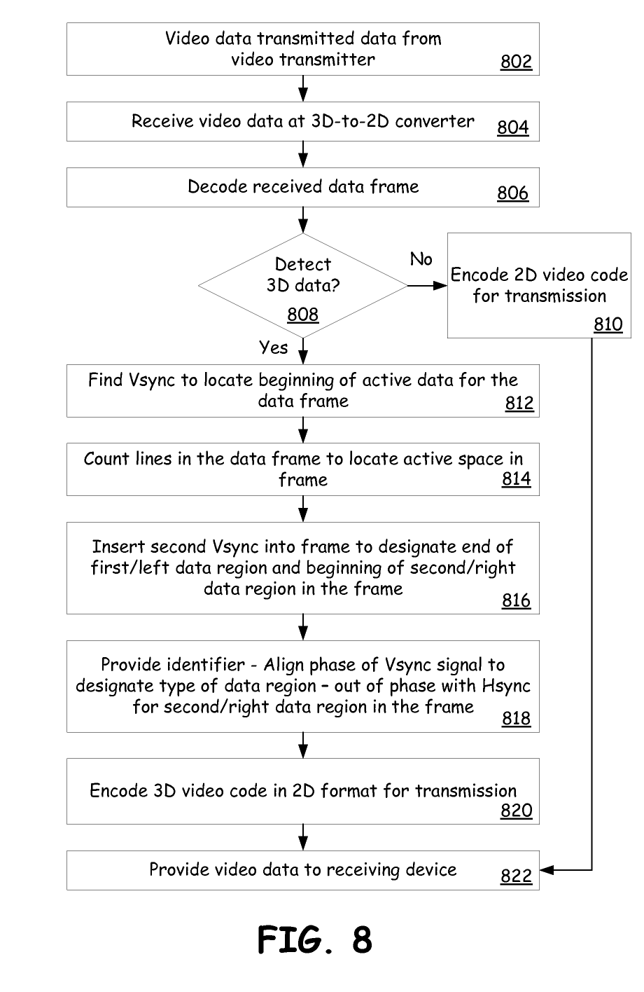

FIG. 8 is a flowchart to illustrate an embodiment of a process for conversion and utilization of 3D video data. As provided in this illustration, a stream of video data may be transmitted from a video transmitter 802, where the video transmitter may be an HDMI 3D capable video transmitter. In some embodiments, the video data is received by a 3D-to-2D video data converter 804, such as converter 715 illustrated in FIG. 7, and a data frame is decoded 806. In some embodiments, the converter may operate to detect whether 3D video data in contained in the data frame 808. If 3D video data is not detected, the 2D data may be handled in a normal fashion, with the data being encoded for transmission 810 and provided to the receiving device 822 for processing.

In some embodiments, if 3D video data is detected in the data frame 808, then a Vsync signal is found in the data frame to locate the beginning of active data in the data frame 812 for the conversion of the 3D video data, where the video data frame includes a first region of data after the Vsync signal. In some embodiments, the conversion of the 3D further includes counting the lines of active data to locate the active space in the data frame 814, where the number of lines may be 1080 for 1080p video data. In some embodiments, a second Vsync signal is inserted into the data frame to designate an end of the first/left data region and a beginning of a second/right data region 816, thus generating 3D video data in a 2D format. In some embodiments, an identifier is provided to distinguish between data regions. In the illustration, while the phase of the first Vsync may be aligned with an Hsync signal, the phase of the second Vsync may be adjusted to be unaligned with any Hsync signal to identify the second/right data region in the data frame 818. In some embodiments, the 3D video data in 2D video format is encoded for transmission 820 and provided to the receiving device 822.

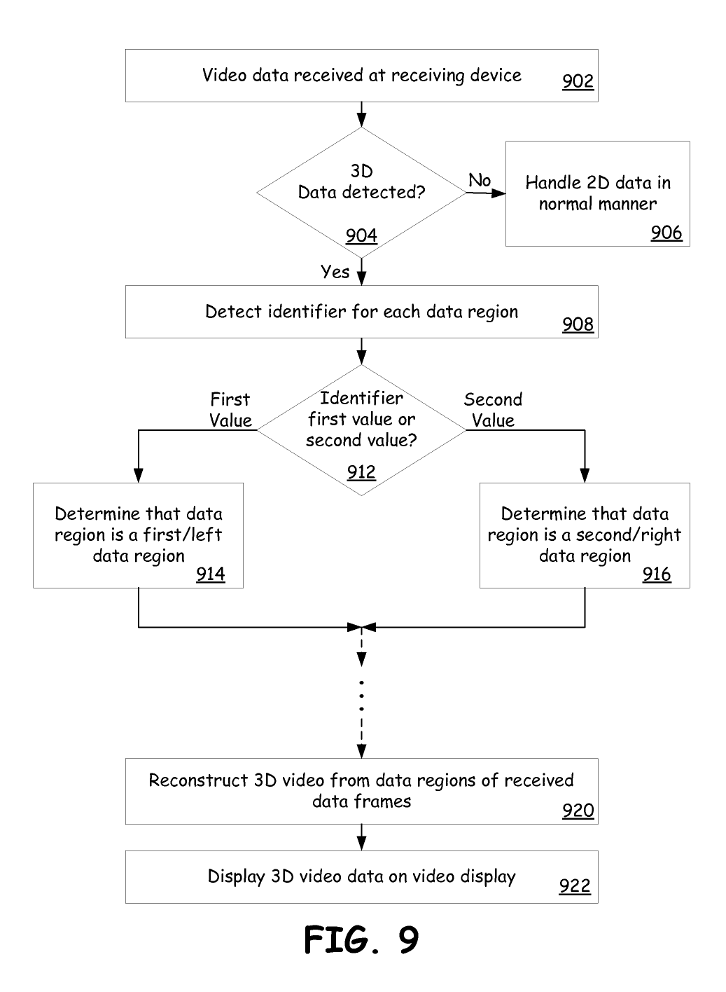

FIG. 9 is a flowchart to illustrate an embodiment of a process for handling 3D video data in 2D video data format. In this illustration, video data is received at a receiving device 902, where the receiving device is a device without 3D data decoding capability. In some embodiments, a determination is made whether 3D video data in 2D video format has been received at the receiving device 904, where the existence of 3D video data may be based at least in part on the presence of an identifier to distinguish between data regions of the 3D video data. In some embodiments, 3D data may be detected by the existence of an identifier including a Vsync signal that is not phase aligned with an Hsync signal, by the receipt of separate signal to distinguish data regions, or by the receipt of a command to distinguish data regions. In some embodiments, the receiving device may include decoding hardware for interlaced mode video, and may utilize such hardware without additional hardware modification or with minimal hardware modification.

In some embodiments, if 3D data is not present, then the 2D data is handled in a normal manner 906. If 3D video data is present, the receiver then detects an identifier for each data region in the received data frames 908 and determines whether the identifier is a first value or a second value 912. If the identifier is a first value, such as when a second Vsync signal is in phase with an Hsync signal, then the receiver identifies the following data region as a first/left region of data 914. If the identifier is a second value, such as when the Vsync signal is not in phase with an Hsync signal, then the receiver identifies the following data region as a second/right region of data 916.

Upon completing the processing of the received video data, the receiver reconstructs the received video data in the separate data regions into 3D format for 3D presentation 920. The reconstructed 3D video data may then be presented on a 3D video monitor 922.

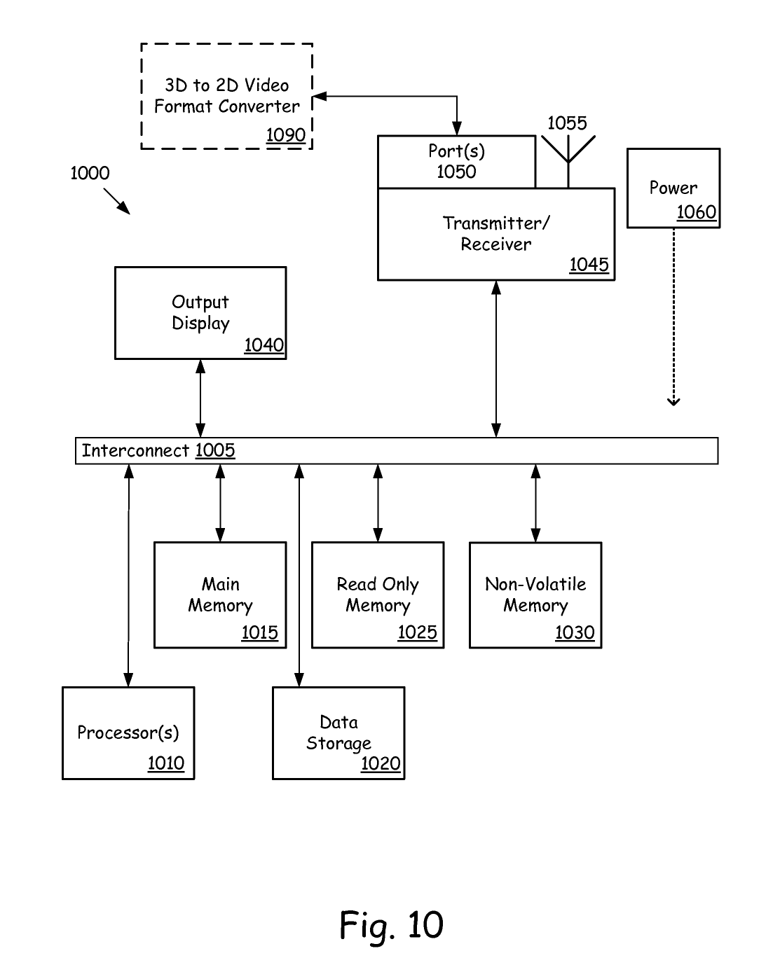

FIG. 10 illustrates an embodiment of an electronic device. In this illustration, certain standard and well-known components that are not germane to the present description are not shown. In some embodiments, the device 1000 is a transmitting device that is transmitting 3D video data or is a receiving device that is receiving 3D video data.

Under some embodiments, the device 1000 comprises an interconnect or crossbar 1005 or other communication means for transmission of data. The data may include various types of data, including, for example, audio-visual data and related control data. The device 1000 may include a processing means such as one or more processors 1010 coupled with the interconnect 1005 for processing information. The processors 1010 may comprise one or more physical processors and one or more logical processors. Further, each of the processors 1010 may include multiple processor cores. The processors 1010 may, for example, be utilized in the processing of video data for transmission or for the processing of received video data. The interconnect 1005 is illustrated as a single interconnect for simplicity, but may represent multiple different interconnects or buses and the component connections to such interconnects may vary. The interconnect 1005 shown in FIG. 10 is an abstraction that represents any one or more separate physical buses, point-to-point connections, or both, connected by appropriate bridges, adapters, or controllers. The interconnect 1005 may include, for example, a system bus, a PCI or PCIe bus, a HyperTransport or industry standard architecture (ISA) bus, a small computer system interface (SCSI) bus, a IIC (I2C) bus, or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements)

In some embodiments, the device 1000 further comprises a random access memory (RAM) or other dynamic storage device as a main memory 1015 for storing information and instructions to be executed by the processors 1010. Main memory 1015 also may be used for storing data for data streams or sub-streams. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may certain registers or other special purpose memory. The device 1000 also may comprise a read only memory (ROM) 1025 or other static storage device for storing static information and instructions for the processors 1010. The device 1000 may include one or more non-volatile memory elements 1030 for the storage of certain elements.

Data storage 1020 may also be coupled to the interconnect 1005 of the device 1000 for storing information and instructions. The data storage 1020 may include a magnetic disk or other memory device. Such elements may be combined together or may be separate components, and utilize parts of other elements of the device 1000.

The device 1000 may also be coupled via the interconnect 1005 to an output display or presentation device 1040. In some embodiments, the display 1040 may include a liquid crystal display (LCD or any other display technology, for displaying information or content to an end user. In some environments, the display 1040 may include a touch-screen that is also utilized as at least a part of an input device. In some embodiments, the display 1040 may be utilized for the presentation of 3D video data. In some environments, the display 1040 may be or may include an audio device, such as a speaker for providing audio information, including the audio portion of a television program.

One or more transmitters or receivers 1045 may also be coupled to the interconnect 1005. In some embodiments, the device 1000 may include one or more ports 1050 for the reception or transmission of data. In some embodiments, the one or more ports may include one or more HDMI ports. In some embodiments, an HDMI may be coupled with a 3D-to-2D converter 1090 for the conversion of 3D data from 3D video format to 2D video format. The device 1000 may further include one or more antennas 1055 for the reception of data via radio signals, such as a Wi-Fi network.

The device 1000 may also comprise a power device or system 1060, which may comprise a power supply, a battery, a solar cell, a fuel cell, or other system or device for providing or generating power. The power provided by the power device or system 1060 may be distributed as required to elements of the device 1000.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs that are not illustrated or described. The illustrated elements or components may also be arranged in different arrangements or orders, including the reordering of any fields or the modification of field sizes.

The present invention may include various processes. The processes of the present invention may be performed by hardware components or may be embodied in computer-readable instructions, which may be used to cause a general purpose or special purpose processor or logic circuits programmed with the instructions to perform the processes. Alternatively, the processes may be performed by a combination of hardware and software.

Portions of the present invention may be provided as a computer program product, which may include a computer-readable storage medium having stored thereon computer program instructions, which may be used to program a computer (or other electronic devices) to perform a process according to the present invention. The computer-readable storage medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/computer-readable medium suitable for storing electronic instructions. Moreover, the present invention may also be downloaded as a computer program product, wherein the program may be transferred from a remote computer to a requesting computer.

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

What is claimed is:

1. A method comprising:
receiving a multimedia data stream including video data utilizing an interface protocol;
determining that the received video data includes three-dimensional (3D) video data, each frame of the video data including a first vertical synchronization (Vsync) signal prior to an active data region, the active data region including a first data region and a second data region; and
converting the 3D video data from a 3D data format to a two-dimensional (2D) video format, where converting the 3D video data includes:
identifying a region between the first data region and the second data region,
inserting a second Vsync signal between the first data region and the second data region, and
providing an identifier to distinguish between the first data region and the second data region.

2. The method of claim 1, wherein the identifier includes a phase of the second Vsync signal.

3. The method of claim 2, wherein inserting the second Vsync signal includes establishing the phase of the second Vsync out of alignment with a phase of horizontal synchronization (Hsync) signals.

4. The method of claim 1, wherein the identifier includes a value of a command that is unused in the interface protocol.

5. The method of claim 1, wherein the identifier includes a separate signal to identify the first data region and the second data region.

6. The method of claim 1, wherein the interface protocol is one of HDMI™ (High Definition Multimedia Interface), DVI™ (Digital Video Interface), or DisplayPort™.

7. The method of claim 1, where the first data region is either a left data region for presentation to a left eye of a viewer or a right data region for presentation to a right eye of the viewer and the second data region is the other of the left data region or the right data region.

8. The method of claim 1, further comprising transmitting the converted video data to a receiving device, where the receiving device is not operable to decode the 3D video format.

9. An apparatus to convert three-dimensional (3D) video data to a two-dimensional (2D) data format comprising:
a port to receive video data via an interface protocol;
a decoder to decode the received video data;
a detector to detect received 3D video data, the received 3D video data including a first vertical synchronization (Vsync) signal prior to an active data region, the active data region including a first data region and a second data region;
a line counter to identify a region between the first data region and the second data region;
a signal inserter to insert a second Vsync signal between the first data region and the second data region; and
an encoder to encode the converted video data;
wherein the apparatus is to provide an identifier to distinguish between the first data region and the second data region.

10. The apparatus of claim 9, wherein the identifier includes a phase of the second Vsync signal.

11. The apparatus of claim 10, wherein the signal inserter inserting the second Vsync signal includes the signal inserter establishing the phase of the second Vsync out of alignment with a horizontal synchronization (Hsync) signal.

12. The apparatus of claim 9, wherein the identifier includes a value of a command that is unused in the interface protocol, the apparatus to transmit the command to identify a type of data region.

13. The apparatus of claim 9, wherein the identifier includes a separate signal to identify the first data region and the second data region.

14. The apparatus of claim 13, further comprising a connection to a signal wire for transmission of the separate signal.

15. The apparatus of claim 9, wherein the interface protocol is one of HDMI™ (High Definition Multimedia Interface), DVI™ (Digital Video Interface), or DisplayPort™.

16. The apparatus of claim 9, where the first data region is either a left data region for presentation to a left eye of a viewer or a right data region for presentation to a right eye of the viewer and the second data region is the other of the left data region or the right data region.

17. A system comprising:
a converter apparatus to convert three-dimensional (3D) video data to a two-dimensional (2D) format, wherein the converter apparatus includes modules to:
detect received 3D video data, the received 3D video data including a first vertical synchronization (Vsync) signal prior to an active data region, the active data region including a first data region and a second data region,
identify a region between the first data region and the second data region,
insert a second Vsync signal between the first data region and the second data region, and
provide an identifier to distinguish between the first data region and the second data region; and
a receiving device coupled with the converter apparatus to receive the converted video data and reconstruct the 3D video data from the converted video data, the receiving device to distinguish between the first data region and the second data based at least in part on the identifier.

18. The system of claim 17, wherein the identifier includes a phase of the second Vsync signal in relation to horizontal synchronization (Hsync) signals.

19. The system of claim 18, wherein the converter apparatus is to establish a phase for the second Vsync signal that is out of phase with the Hsync signals.

20. The system of claim 17, wherein the identifier includes a value of a command that is unused in the interface protocol, the converter apparatus to transmit the command to identify a type of data region.

21. The system of claim 17, wherein the identifier includes a separate signal to identify the first data region and the second data region.

22. The system of claim 21, further comprising a signal wire between the converter apparatus and the receiving device for transmission of the separate signal.

23. The system of claim 17, wherein the interface protocol is one of HDMI™ (High Definition Multimedia Interface), DVI™ (Digital Video Interface), or DisplayPort™.

24. The system of claim 17, wherein the receiving device is further to detect the existence of 3D data based at least in part on the identifier.

25. A computer-readable medium having stored thereon data representing sequences of instructions that, when executed by a processor, cause the processor to perform operations comprising:
receiving a multimedia data stream including video data utilizing an interface protocol;
determining that the received video data includes three-dimensional (3D) video data, each frame of the video data including a first vertical synchronization (Vsync) signal prior to an active data region, the active data region including a first data region and a second data region; and
converting the 3D video data from a 3D data format to a two-dimensional (2D) video format, where converting the 3D video data includes:
identifying a region between the first data region and the second data region,
inserting a second Vsync signal between the first data region and the second data region, and
providing an identifier to distinguish between the first data region and the second data region.
